(19) United States
(12) Patent Application Publication
(10) Pub. No.: US 2002/0073163 A1
(43) Pub. Date: Jun. 13, 2002

(54) Systems and methods for supporting document centered discussion across heterogeneous devices and displays

(75) Inventors: Elizabeth F. Churchill, San Francisco, CA (US); Jonathan Trevor, Santa Clara, CA (US); Catherine C. Marshall, San Francisco, CA (US)

Correspondence Address: OLIFF & BERRIDGE, PLC, P.O. BOX 19928, ALEXANDRIA, VA, 22320, US

(73) Assignee: Fuji Xerox Co., Ltd.

(21) Appl. No.: 09/733,894

(22) Filed: Dec. 12, 2000

(51) Int. Cl. G06F 15/167; G06F 15/173

(52) U.S. Cl. 709/214; 709/223

(57) ABSTRACT

The decreasing cost of communication has led to a focus on including workgroup participants based on their abilities rather than their physical location. However, collaboration workgroup participants are still dependent on electronic documents which are difficult or impossible to view on smaller web-enabled devices such as web-enabled phones, web-enabled personal digital assistants and the like. If the documents can be viewed at all, they must be pre-encoded for a single format supported across all devices, or the range of participating devices must be limited to a single display type. Furthermore, some document types may require hardware upgrades including expanded memory to load the additional code necessary to view the document. This excludes impromptu workgroup formation since the device types of the collaborating users and/or the set of required documents for a meeting cannot always be predicted. Moreover, even when a document has been previously encoded, collaboration is difficult due to the inability to view the overall structure of the page. Accordingly the techniques presented allow for impromptu access to documents in the native application format. The collaboration of users within a document is facilitated by allowing the users to indicate context within the document for collaboration based on the display capabilities of each user's device.

### BACKGROUND OF THE INVENTION

1. Field of Invention

This invention relates to supporting document centered discussion across heterogeneous devices and communication-enabled display devices.

2. Description of Related Art

The decreasing costs of communication services have prompted the creation of static and impromptu workgroups that span distances. As a result, the focus of workgroup participation has changed from physical availability to temporal availability. Participants in discussion or collaboration groups are more frequently selected based on the value added by their participation rather than their mere physical proximity. A user of a personal communication system (PCS) phone can now remain in voice contact with the office wherever these communication facilities are available. Personal communications system operators now also provide web-enabled phones that give users access to Internet sites supporting one or more wireless markup languages such as wireless markup language, or WML.

Web-enabled phone users can read documents encoded for the wireless access protocol supported by a built-in micro-browser of a web-enabled display device, such as web-enabled phones. Alternately, users without web-enabled phones typically discuss documents with each other by reading them aloud over a personal communication system voice link. Thus, if a first user wishes to collaborate with another user, the document must be either read aloud over the voice link or translated into one of the wireless markup language formats already supported by the built-in micro-browser of the web-enabled display devices. Pre-encoding documents for suitable wireless markup language formats requires considerable advance planning on the part of the discussion participants. Moreover, in order to support the many different display capabilities of the different devices, each user must know the display characteristics of the device being used by each static and/or impromptu discussion participant. As each web-enabled device is capable of displaying different amounts of text, the same document may be rendered differently on each type of web-enabled device. As each user sees a different rendering of the document, it becomes difficult to describe the current focus of attention for the discussion within a document without page, paragraph and sentence cues. Navigation and collaboration among the users is therefore difficult.

Thus, even if a user is able to provide access to a document by encoding the document for one specific wireless access protocol, differences will exist between the amount of text displayed on each of the different types of web-enabled devices. For example, some web-enabled phones may display 5 lines each having 20 characters of text. In contrast, a web-enabled personal digital assistant or PDA might display 10 lines, each having 31 characters of text. Therefore, two users, one using a web-enabled phone and the other using a web-enabled personal digital assistant or PDA, would also have difficulty orienting and navigating within the encoded document due to the dissimilarity of display device types. This navigation problem is increased by the smaller display size of most portable web-enabled devices. In particular, the location within the page and the paragraph structure of a document is difficult to determine with the limited number of lines of display on most portable web-enabled devices. The structure of even a simple sentence changes when the widths and/or number of lines of the display devices differ.

The differing display capabilities also make it difficult to collaborate within a document since a first user will find it difficult to explain the focus of the first user's attention within a document to a second user having a different type of web-enabled device. In these situations, users will typically resort to voice prompting. In voice prompting, the first user reads out the portion of the text that is the first user's current focus of attention within the document. The second user searches for and navigates to the specified portion of the document. However, one or more of the users may be unable to read out the information without divulging sensitive information to nonusers in the same area. For example, a user attempting a discussion in an airport lounge would not want those voice prompts about sensitive material to be overheard. Also, voice prompting is slow and subject to error, as the portion of the text searched for may appear in multiple locations with a given document. These access, orientation and co-navigation problems make collaboration difficult across heterogeneous communication-enabled devices.

### SUMMARY OF THE INVENTION

Accordingly, systems and methods that provide for device independent sharing of documents would be advantageous. Also, systems and methods that provide context indication between users of heterogeneous displays would also be advantageous.

This invention provides device-independent techniques for supporting document-centered discussion across heterogeneous devices and displays, allowing a users to invite other users to collaboratively discuss a document while providing context information that selectively provides each user with information about the other users' focus of attention within a document.

Furthermore, this invention provides device-independent techniques that allow an impromptu sharing of documents independent of the document encoding format and independent of the display device characteristics.

This invention also provides a technique for notifying display devices of available updates using a novel model of information transfer.

### BRIEF DESCRIPTION OF THE DRAWINGS

Various exemplary embodiments of this invention will be described in detail, with references to the following figures, wherein:

FIG. 1 is a block diagram of a first exemplary embodiment of a system for supporting document centered discussion according to this invention;

FIG. 2 is a block diagram of a first exemplary embodiment of a system for supporting document centered discussion according to this invention;

FIG. 3 is an exemplary embodiment of an invitation storage memory data structure according to an exemplary embodiment of this invention;

FIG. 4 is an exemplary view storage memory data structure according to an exemplary embodiment of this invention;

FIG. 5 is an exemplary embodiment of a user contact memory data structure according to an exemplary embodiment of this invention;

FIG. 6 shows exemplary embodiment of a document translation and device translation facility according to an exemplary embodiment of this invention;

FIG. 7 is a flowchart outlining an exemplary embodiment of a method for supporting document centered discussion according to this invention; and

FIG. 8 is an exemplary embodiment of a display according to an this invention.

### DETAILED DESCRIPTION OF EXEMPLARY EMBODIMENTS

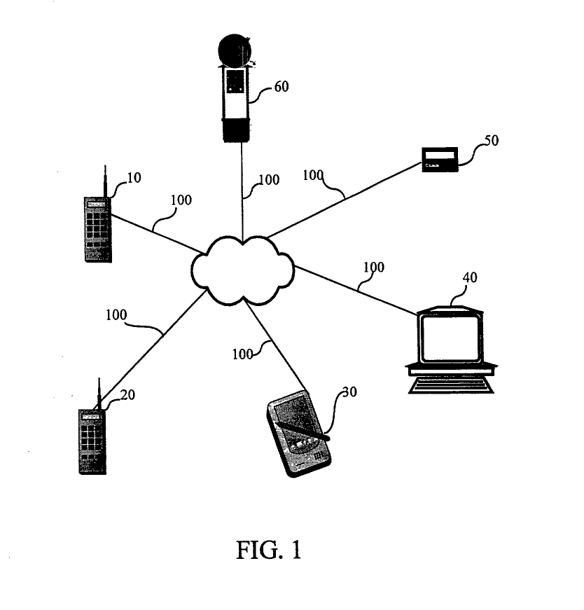

FIG. 1 shows an exemplary block diagram of a first exemplary embodiment of a system for supporting document centered discussion across heterogeneous devices and displays according to this invention. As shown in FIG. 1 a first web-enabled phone 10 communicates over a number of the communication links 100 with a discussion manager 60. The discussion manager 60 facilitates discussion between the web-enabled phone 10 and other devices, such as for example, a second web-enabled phone 20, a web-enabled personal digital assistant or PDA 30, a web-enabled personal computer 40, a web-enabled two-way pager device 50 or any other known or later-developed device capable of communicating over the communication links 100.

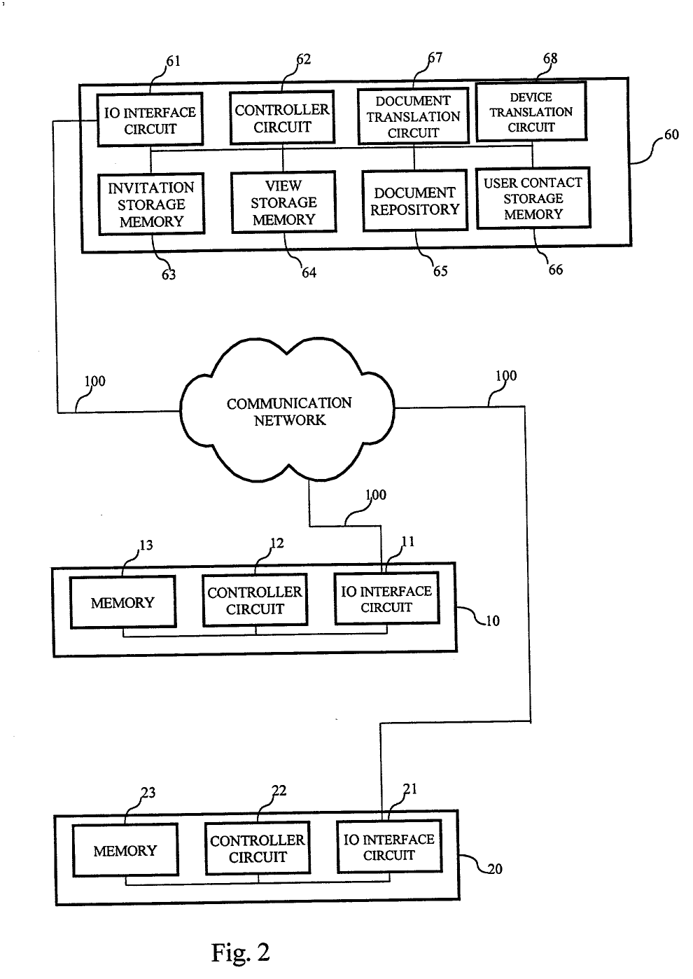

FIG. 2 shows an expanded view of an exemplary embodiment of a system for supporting document centered discussion across heterogeneous devices and displays according to this invention. As shown in FIG. 2, the web-enabled phone 10 includes an input/output interface circuit 11 connectable to one of the communication links 100. The input/output interface circuit 11 is also connected to a controller circuit 12 and a memory 13. The discussion server 60 includes a discussion manager controller circuit 62, an invitation storage memory 63, a view storage memory 64, a user contact storage memory 66, a document repository 65, a document translation circuit 67 and a device translation circuit 68 connected through an input/output interface 61 to one of the communication links 100. The second web-enabled phone 20 includes a controller circuit 22, a memory 23 and an input/output circuit 21 connected to one of the communication links 100.

In the various exemplary embodiments according to this invention, the invitation storage memory 63, the view storage memory 64, the user contact storage memory 66, the document repository 65, the document translation circuit 67 and the device translation circuit 68 may be located within the web-enabled phone 10, within the discussion manager 60 or may be located remotely and accessed over one of the communication links 100. Thus, it will be apparent that any known or later developed method of storing the information that facilitates access by the web-enabled phone 10 and/or any other communication-enabled device may be used in practicing this invention.

The discussion manager controller circuit 62 controls the entering of information into the invitation storage memory 63, the view storage memory 64 and/or the user contact storage memory 66. When the user of the web-enabled phone 10 creates an invitation to discuss a document, the discussion manager controller circuit 62 creates an invitation entry in the invitation storage memory 63 using information from the user contact storage memory 66. The user contact storage memory 66 contains information about each contact-able user, including device identifiers for each device to be used in a discussion.

The invitation entry combines the name of a document, a location of the document and the inviter's focus of attention within the document into the context identifier portion of the invitation entry. The invitation entry also includes one or more of an invitee identifier portion identifying the user invited to the discussion, an inviter identifier portion identifying the user issuing the invitation, a time and date stamp portion identifying the time and date the invitation was issued, and/or a status indicator portion indicating whether the invitation has been accepted, refused, not yet broadcast or broadcast but still awaiting reply. The document location may be the document repository 65, the memory 13 of the web-enabled phone 10, or a location on any other remotely accessible device, server or storage facility that can be accessed over one or more of the communication links 100.

The discussion manager controller 62 searches the invitation storage memory 63 to determine if any of the currently available devices have been invited to a discussion. If an invitation is found that matches the device identifier of the second web-enabled phone 20, the second web-enabled phone 20 is notified of the invitation by the discussion manager 60. The notification may be accomplished by any protocol supported by the second web-enabled phone 20, including but not limited to a wireless access protocol or WAP-alert, a short message service communication, email notification, or any other known or later developed technique for notifying the user of a currently-available device.

When notified of an invitation to a discussion by the discussion manager 60, the web-enabled phone 20 may, for example, prompt the user of the web-enabled phone 20 to accept or decline the invitation. The user of web-enabled phone 20 may be prompted by a pop-up window a dialog box, an audible prompt or any other known or later developed technique for alerting the user of the web-enabled phone 20 of the invitation to the discussion.

In one exemplary embodiment of the invention, if the user accepts or rejects an invitation, the web-enabled phone 20 sends a notification to the discussion manager 60 using any of the previously discussed notification methods.

When the discussion manager controller circuit 62 receives the notification from web-enabled phone 20, the discussion manager controller circuit 62 updates the invitation status portion of the invitation entry in the invitation storage memory 63. If the notification is an acceptance, a view entry is also created in the view storage memory 64 reflecting the accepted invitation. The view entry includes one or more of an invitee identifier which identifies the specific device accepting the invitation, a device type previously associated with the corresponding invitee device identifier in the user contact storage memory 66, and/or a context identifier specifying the document name, the document location and/or the invitee's current focus of attention.

The document translation circuit 67 allows different types of devices to discuss the same document. The document translation circuit 67 provides a document translation facility that converts documents from the documents' native application and/or native operating system formats into a standard document format for processing. For example, one of the document translation services of the document translation circuit 67 reads and writes Microsoft Word® documents to and from a standard document format, such as rich text format, or “RTF”.

When a user requests a document, the discussion manager controller circuit 62 transfers the document to the document translation circuit 67, which translates the requested document to a standard document format. The discussion manager controller circuit 62 then transfers the standard format document to the device translation circuit 68.

The device translation circuit 68 translates the standard format document from the standard document format to one or more device-specific documents, each in a device specific format. The device specific format is typically the format used to manipulate documents on a specific web-enabled device. For example, a web-enabled device might support displaying and writing documents in a wireless markup language, i.e., the WML format; the hypertext markup language, i.e., the HTML format; the PALM document format, i.e. the PALM DOC format, or any other known or later developed technique for encoding information supported by a specific web-enabled device. In this way, no additional software or program code needs to be added to the specific web-enabled device. Thus documents may be shared without pre-formatting and without pre-selection.

When an invitation to discuss a document is identified by the discussion manager controller circuit 62, a specific translation of the document specified in the context identifier is retrieved by the web-enabled phone 20 from the document repository 65 via the document translation circuit 67 and the device translation circuit 68. The web-enabled-phone specific translation that is received by the web-enabled phone 20 is based on the invitee device specified in the user contact storage memory for the web-enabled phone 20. The view into the retrieved document is synchronized with the context specified in the context of the invitation entry. The status of the invitation entry is updated to reflect the acceptance of the invitation. The time and date are recorded.

The discussion manager controller 62 then creates an entry in the view storage memory 64 including one or more of the invitee identifier, the device type as specified in the user contact storage memory 66, and/or the context identifier. The context identifier of the view entry in the view storage memory 64 includes the current focus of attention for the specified invitee. As an invitee moves within the specified document, the context identifier in the view storage memory 64 is updated with new view information reflecting the invitee's changing focus of attention.

It will be apparent that users may switch between viewing the focus of attention of each participant in a discussion by changing the parameters of a search through the invitation storage memory 63. A search for a specific document with no additional search criteria specified for invitee will show all users currently viewing that specific document. For example, this option may be selected by the user of the web-enabled personal computer 40 to view the focus of attention of all users in a single document discussion.

The discussion manager controller circuit 62 monitors the view storage memory 64 for updates to the context identifiers of each participating user. There is no limit to the number of discussions that a user may accept.

If the user of the web-enabled phone 20 navigates within the document, the changes in the current focus of attention of that user within the document is used to update the context identifier of the view entry for the web-enabled phone 20. This allows other users to determine the current context of the user of web-enabled phone 20. Similarly, as web-enabled phone user 10 navigates within the document, the web-enabled phone user 20 may receive updates of the current focus of attention of the user of web-enabled phone 10. In this way, collaboration and discussion are facilitated, as each user becomes aware of which portions of the document are being reviewed and/or changed by each other particular user being monitored.

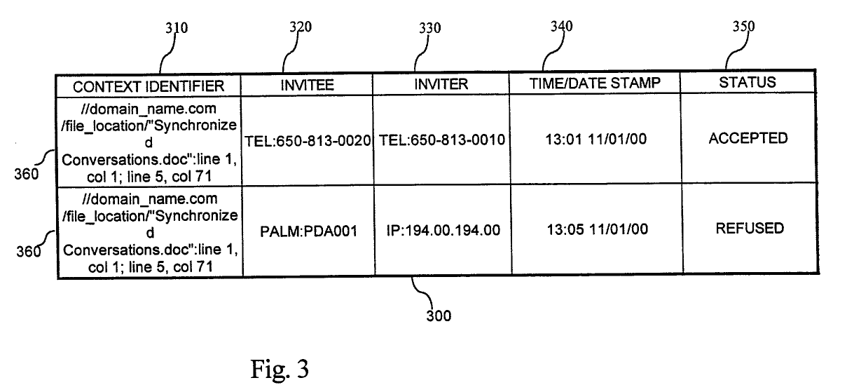

FIG. 3 shows one exemplary embodiment of an invitation storage memory data structure 300 that can be used with the invitation storage memory 63. The invitation storage memory data structure 300 contains one or more of a context identifier portion 310, an invitee portion 320, an inviter portion 330, a time/date stamp portion 340, and/or a status portion 350.

The web-enabled phone 10, the web-enabled phone 20, the web-enabled personal digital assistant 30, the web-enabled personal computer 40, the web-enabled two-way pager 50 and/or any other suitable communication device are each able to invite users to discuss a document by issuing an invitation to a specific user or a group of users. In one exemplary embodiment of the invention, the invitation entry 360 is a record in the invitation storage memory data structure 300 in the invitation storage memory 63. Each invitation entry 360 in the invitation storage memory data structure 300 specifies one or more of the invitation context identifier 310, the invitee 320, the inviter 330, the invitation time and date stamp 340, and/or invitation status 350. However, in various other exemplary embodiments of this invention, the invitation can use any other known or later-developed technique to communicate one or more of the document context, the required users and/or the display capabilities to other users.

To invite a user to a discussion, the web-enabled phone 10 selects an invitee user and invitee user device from previously entered information in the user contact storage memory 66. The device identifier of the corresponding invitee user device and the device identifier of the inviting device are then used as the invitee and inviter identifiers in the creation of an invitation entry 360 in the invitation storage memory data structure 300. In this exemplary embodiment, the invitation entry 360 in the invitation storage memory data structure 300 initially includes the context identifier 310, which identifies one or more of the portions of the document, the name and the location of the document to which the identified user is invited to join, the time and date stamp recording when the invitation was extended and/or a status portion indicating whether the invitation has been accepted, refused, broadcast or is awaiting broadcast.

For example, the first invitation entry 360 includes the name, location and current user focus of attention of the inviter within the document in the context identifier 310 as “//domain_name.com/file_location/” Synchronized Conversations.doc”: line 1, col. 1, line 5, col. 71”. The “domain_name/file_location” portion of the context identifier 310 specifies the document repository portion of the context identifier, while the “Synchronized Conversations.doc” portion of the context identifier 310 specifies the file name and the “line 1, col. 1, line 5, col. 71” portion of the context identifier 310 specifies the user focus of attention of the inviter into the document to be discussed. In order to allow each device to reference portions of the document, the exemplary embodiment references the line numbers and the lateral column position of the current focus of attention within the native document format. The line numbers refer to the lines in the text while the columns refer to lateral column positions within each text line. Thus “line 1, col. 1” refers the upper left hand corner of the focus of attention at line 1 and lateral position 1. The portion “line 5, col. 71” refers to the lower left hand corner of the focus of attention at line 5 and lateral column position 71. It will be apparent that any known or later developed technique for encoding the focus of attention may be used in the practice of this invention.

In various exemplary embodiments, the invitee identifier 320 and the inviter identifier 330 are device identifiers. For example, in FIG. 3, the first entry invitee identifier 320 is “TEL:650-813-0020” indicating that the invitee user device accessible over the telephone network at the device address “650-813-0020” is invited to join the discussion with a focus of attention at line 1, lateral column position 1 to line 5 lateral column position 71. Similarly for the second entry, “PALM:PDA001” indicates that the device “PALM:PDA001” accessible over the PALMNET network is also invited to join a discussion. However, any device identifier, including but not limited to an alias, a user name, a media access control or MAC address, a TCP/IP address, a telephone number or any other known or later-developed system or method of differentiating user devices within a communication network may be used in this invention.

The inviter portion 330 of the invitation entry 360 specifies the device identifier of the user extending the invitation. In the first invitation entry 360 of the exemplary invitation storage memory data structure 300 as shown in FIG. 3 , the inviter is specified as accessible over the telephone network at “650-813-0010”. In the second invitation entry 360, the inviter device is specified as accessible over the IP network at device address “194.00.194.00”.

The time and date stamp 340 portion of the invitation entry 360 in the exemplary invitation storage memory data structure 300 indicates when the invitation was extended. For the first invitation entry 360, the date the invitation was extended is specified as Nov. 1, 2000 at 13:01 hours. For the second invitation entry 360, the invitation was extended on Nov. 1, 2000 at 13:05 hours. The time and date stamp 340 facilitate using techniques to automatically purge invitations that are not accepted within a given interval of time. The time and date stamp 340 also allow new invitations to be differentiated from old invitations.

The status portion 350 of the invitation entry 360 in the exemplary invitation storage memory data structure 300 specifies the current status of the invitation. The status may indicate, for example, that an invitation has been “ACCEPTED”, “REFUSED”, “BROADCAST” or “AWAITING BROADCAST”, among other statuses. For example, the first invitation entry 360 has an “ACCEPTED” status indicating that the invitation extended by “TEL:650-813-0010” was accepted by “TEL:650-813-0020” and a discussion was established. In contrast, the status portion 3650 of the second invitation entry 360 indicates that the invitation extended by “IP:194.00.194.00” was refused by “PALM:PDA001”.

Many of the invitee devices use communication systems of limited bandwidth. Therefore a method to reduce the communication bandwidth requirements created by monitoring the invitation storage memory 63 is provided by a novel notification technique according to this invention. For example, most personal communication system or PCS, phones constantly monitor the status of the communication link 100 to determine if a call is being made to the personal communication system PCS telephone. The web-enabled phone 20 is then alerted by a notification message sent by the discussion manager controller 62. This is known as a push model of information transfer.

In contrast, in various exemplary embodiments, the personal digital assistant or PDA 30 can use a polled notification technique in which the personal digital assistant or PDA 30 requests messages when the personal digital assistant or PDA 30 initially establishes communication over one of the communication links 100 and at specified times thereafter. Messages received before the communication link 100 is established or before the personal digital assistant or PDA 30 is activated are saved in a queue and forwarded at a later time. Therefore, at specific intervals following the activation of the personal digital assistant or PDA 30, the pending messages are downloaded from a message queue associated with that personal digital assistant or PDA 30.

Accordingly, the systems and methods of this invention provide a technique that identifies the discussion manager notifications and places them ahead of other messages in the message queue associated with that personal digital assistant PDA 30. Therefore, if the personal digital assistant or PDA 30 is involved in a discussion, the messages reflecting updated view entries will not be delayed by other messages in the message queue. Various exemplary embodiments of this invention therefore provide for a re-ordering of the message queue to place discussion manager messages ahead of all other messages in the message queue.

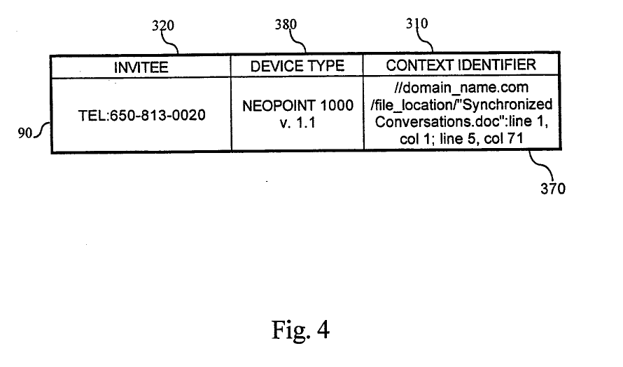

FIG. 4 shows one exemplary embodiment of a view storage memory data structure 370 that can be used with the view storage memory 64. The user of the web-enabled phone 20 can accept an invitation to discuss a document by, for example, pressing an appropriate key or selecting an option on the display or pop-up form or alert. The view storage memory 64 is updated to include one or more of the invitee identifier 320, a device type identifier 380 and the document context identifier 310 for the document currently being viewed.

The invitee identifier 320 identifies a device within the system. The device type identifier 380 provides information about the display and communication capabilities of the invitee's device. The context identifier 310 identifies the document name, the location and the focus of attention information for the discussion document. As the invitee navigates within the document, the view entry 390 of the view storage memory data structure 370 for that invitee is updated, so that other users may determine the current focus of attention of the user of web-enabled phone 20.

For example, the invitee 320 portion of the first view entry 390 in the exemplary view storage memory data structure 370 shows that the device accessible at address “TEL:650-813-0020” was invited to, and has joined, a discussion. The device type 380 can be used to determine the capabilities of the invitee's device by searching for the device type display characteristics of the identified device in the user contact storage memory 66. The context identifier 310 portion indicates the document “Synchronized Conversations.doc”, located at “domain_name/file_location”, with that invitee's embodiment of a focus of attention at line 1, lateral column position 1 to line 5 lateral column position 71 is currently being discussed.

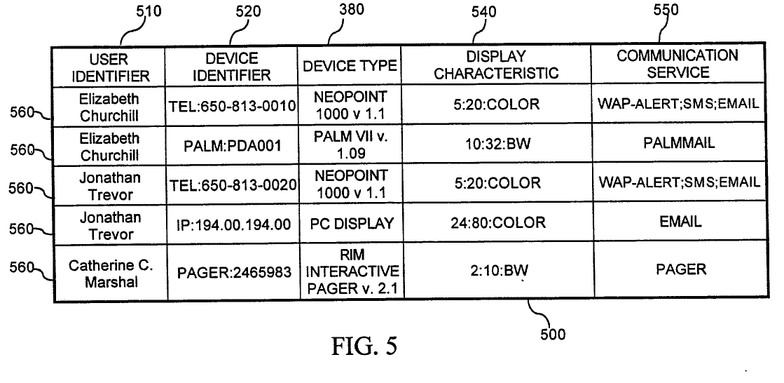

FIG. 5 shows an exemplary user contact storage memory data structure 500 contained in user contact storage memory 66. The user contact storage memory data structure 500 includes a user identifier 510, a device identifier 520, a device type 380, a display characteristic 540 and a communication service 550. The exemplary user contact storage memory data structure 500, shows multiple entries 560.

The user identifier 510 is used to identify a user of the system. There may be multiple identical user identifiers indicating the user has multiple communication-enabled devices. Each communication-enabled device is addressed via a device identifier 520. The device type 380 can be used to indicate the capabilities of the identified device or can be used to identify and handle idiosyncrasies of specific communication enabled devices. The display characteristic 540 indicates display characteristics which can include color support, number of lines of text that can be displayed or the number of lateral column positions of text that can be displayed or any other display characteristic. The communication service 550 portion indicates which communication services can be used to notify the identified device. Any type of communication service can be used.

For example, the first user contact storage memory entry shows user identifier 510 as “Elizabeth Churchill”. As can be seen in the second user contact storage memory entry, the user identified as “Elizabeth Churchill” can be reached through the devices accessible at device identifier 520 “TEL:650-813-0010”, and device identifier 520 “PALM:PDA0001”.

The device type 380 portion of the first and second user contact storage memory entries indicate the devices are “NEOPOINT 100 v.1.1” and a “PALM VII v 1.09” devices. The display characteristic 540 of the first and second user contact storage memory entries indicate the first entry has a color display capable of displaying 5 lines of 20 lateral column positions of text. The second entry is a black and white display capable of displaying 10 lines of 32 lateral column positions of text. The communication service 550 portion for the first entry indicates the first entry is accessible via WAP-ALERTS, SMS and e-mail. The second entry is accessible via the PALMMAIL communication service.

Similarly, the user identifier 510 for the third and fourth entries indicate the devices are used by “Jonathan Trevor”. The device identifier 520 portions indicate that the third entry is accessible at “TEL:650-813-0020” over the telephone network while the fourth entry “IP: 194.00.194.00” is accessible over a TCP/IP network.

The third entry device type 380 contains “NEOPOINT 1000 v.1.” with a display characteristic 550 indicating color support for 5 lines of 20 lateral column positions of text and communication service 550 indicating that that device may be accessed via WAP-ALERT, SMS or e-mail.

The fourth entry device type 530 of “PC DISPLAY” with a display characteristic 550 indicating color support for 24 lines of 80 lateral column positions of text and communication service 550 indicating that that device may be accessed via e-mail.

The fifth user contact storage memory entry 560 shows user identifier 510 as “Catherine C. Marshall” reachable through the device accessible at device identifier 520 “PAGER:2465983” having device type “RIM INTERACTIVE PAGER v.2.1”. The fifth entry device display characteristic 540 indicates supports for a black and white display of 2 lines of 10 lateral column positions of text. The communication service 550 portion of the fifth entry indicates support for the pager communication service.

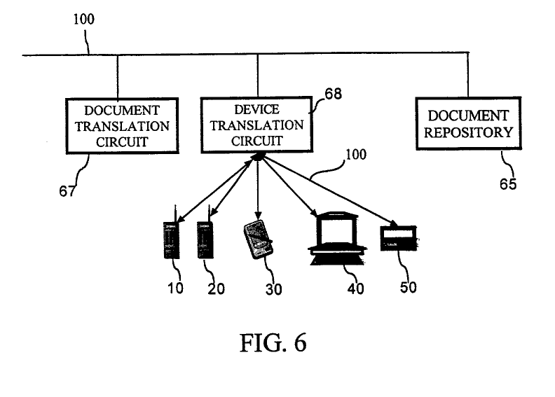

FIG. 6 shows in greater detail one exemplary embodiment of the document translation circuit 67 and the device translation circuit 68. The document translation circuit 67 mediates access to the document repository 65 for the device translation circuit 68 by dynamically translating the document from an application-specific or operating-system specific format to a standard format document. The device translation circuit 68 mediates access to the document repository 65 for specific device types by translating the dynamically-generated standard-format document into a device-specific format which is directly supported by a corresponding one of the web-enabled phone 20, the web-enabled personal digital assistant 30, the web-enabled personal computer 40, or the web-enabled two-way pager 50. In this way, access to all document formats may be provided without requiring the web-enabled phone 20 to load the specific application that created the document.

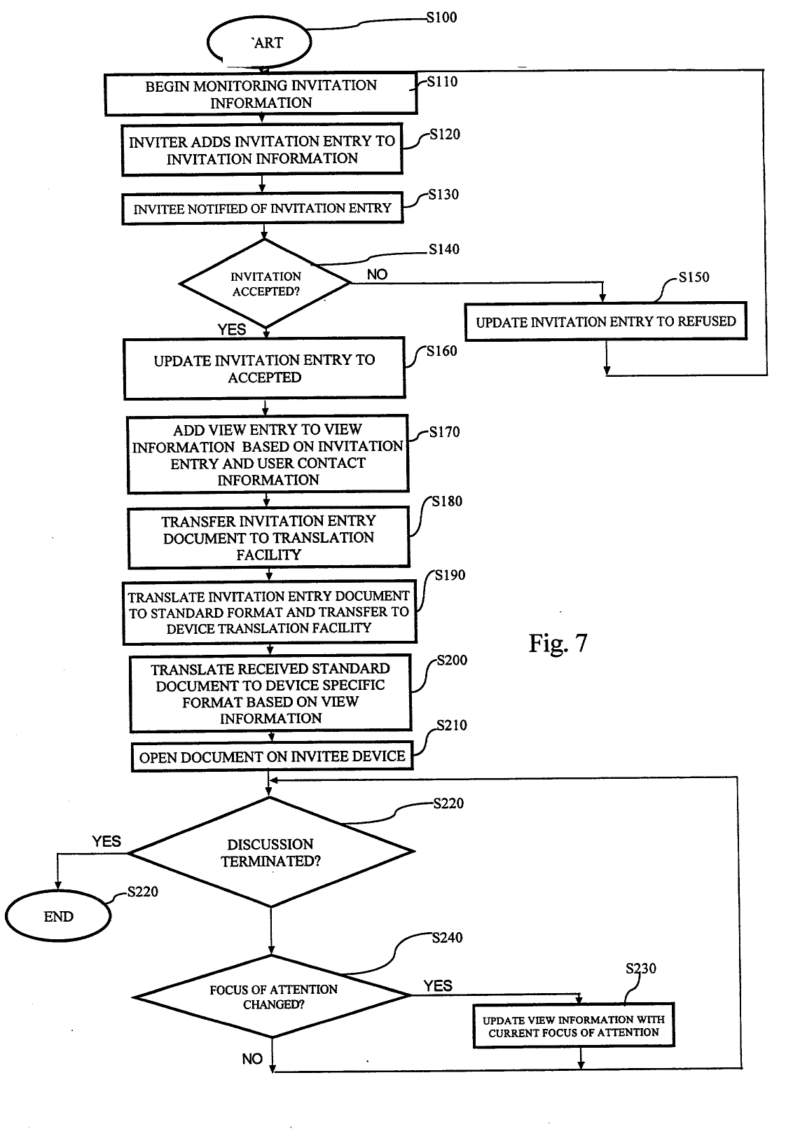

FIG. 7 is a flowchart outlining one exemplary embodiment of a method for supporting document centered discussion across heterogeneous devices and displays according to this invention. Beginning in step S100, control immediately continues to step S110. In step S10 the invitation information is monitored for new invitation entries. Entries may be made to the invitation information by individual devices directly creating invitation information or the individual devices may request invitation information be entered. Control is then transferred to step S120.

An invitation entry is added to the invitation information in step S120. In various exemplary embodiments of this invention, the invitation information includes invitee information and discussion context information including a focus of attention within the document to be discussed. Control is then transferred to step S130.

The invitee device identified in the invitation is notified of the invitation to discuss in step S130. The notification may be via a pop-up alert or WAP-alert or an SMS message on a personal communication phone, an e-mail message, paging information or any other known or later developed technique of notification.

Control then continues to step S140 where a determination is made whether the invitee accepts the invitation to the discussion. If the response is not an acceptance, control is transferred to step S150 where the invitation entry status is updated and control is immediately transferred to step S110. The steps S110-S150 are repeated until step S140 determines that an invitation has been accepted.

If step S140 determines the invitation has been accepted, control is immediately transferred to step S 160 where the invitation entry is updated to reflect the acceptance and control continues to step S170. In step S170 an entry is added to the view information based on the accepted invitation entry and corresponding user contact information. The user contact information can include previously entered user contact information such as the device type and/or display capabilities of a user's devices.

Control is then transferred to step S180 where the document referenced in the invitation entry is transferred to the document translation facility and control is transferred to step S190. In step S190, the document translation facility translates the application or operating system specific document to a standard document format. The standard document format is then transferred to the device translation facility.

In step S200, the standard format document is translated to a device specific format based on the view information. For example, the view information may contain a device type which indicates or can be used to determine the display capabilities of the device. Control continues to step S210.

In step S210, the device specific document is opened on the invitee device. Depending on the specific device type and the resources available for processing, a portion of the device specific document may be transferred to the invitee device or the entire document may be transferred. If only a portion the document is transferred, then as the current focus of attention changes, additional portions of the document will be transferred from the device translation facility. This allows smaller and less expensive devices to be used since memory and/or power requirements will be reduced.

Control continues to step S220 where a determination is made whether the invitee has terminated participation in the discussion. The discussion may be terminated by pressing a function key or any other known or later developed method of indicating termination. If the determination is made that the discussion has been terminated, control continues to step S220 and the process ends, otherwise control continues to step S240 where a determination is made whether the current focus of attention for the particular device has changed.

If the current focus of attention for the device has changed, the associated view information is updated with the current focus of attention information. This allows other users observing the view information to be aware of the current focus of attention within the document for the invitee user. If the current view has not changed, control jumps directly to step S220 without updating the view information and the steps S220-S230 are repeated until it is determined at step S220 that the process should be terminated.

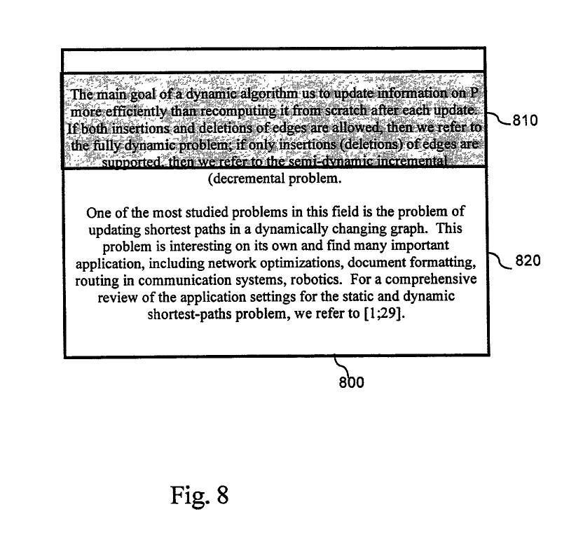

FIG. 8 shows one exemplary display 800 with a visual indication 810 for a portion of a document 820. The visual indication 810 indicates the current focus of attention of a particular user within the document 820. The visual indication 810 of that user's focus of attention might include highlighting the text, italicizing the text, changing a color of the text or any other known or later-developed technique that indicates a user's focus of attention or context within a document.

In the various exemplary embodiments outlined above, the discussion manager 60 can be implemented using a programmed general purpose computer. However, the discussion manager 60 can also be implemented using a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowchart shown in FIG. 7 can be used to implement the discussion manager 60.

Each of the circuits 61-68 of the discussion manager 60 outlined above can be implemented as portions of a suitably programmed general purpose computer. Alternatively, circuits 61-68 of the discussion manager 60 outlined above can be implemented as physically distinct hardware circuits within an ASIC, or using a FPGA, a PDL, a PLA or a PAL, or using discrete logic elements or discrete circuit elements. The particular form each of the circuits 61-68 of the discussion manager 60 outlined above will take is a design choice and will be obvious and predicable to those skilled in the art.

Moreover, the discussion manager 60 and/or each of the various circuits discussed above can each be implemented as software routines, managers or objects executing on a programmed general purpose computer, a special purpose computer, a microprocessor or the like. In this case, the discussion manager 60 and/or each of the various circuits discussed above can each be implemented as one or more routines embedded in the communications network, as a resource residing on a server, or the like. The discussion manager 60 and the various circuits discussed above can also be implemented by physically incorporating the discussion manager 60 into a software and/or hardware system, such as the hardware and software systems of an inviting web-enabled device that issues the invitations.

As shown in FIG. 2, the memories, 13 and 23, the invitation storage memory 63, the view storage memory 64, and/or the user contact storage memory 66 can each be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The communication links 100 shown in FIGS. 1, 2 and 6 can each be any known or later developed device or system for connecting a communication device to the discussion manager 60, including a direct cable connection, a connection over a wide area network or a local area network, a connection over an intranet, a connection over the Internet, or a connection over any other distributed processing network or system. In general, the communication links 100 can each be any known or later developed connection system or structure usable to connect devices and facilitate communication.

Further, it should be appreciated that the communication link 100 can be a wired or wireless link to a network. The network can be a local area network, a wide area network, an intranet, the Internet, or any other distributed processing and storage network.

While this invention has been described in conjunction with the exemplary embodiments outlines above, it is evident that many alternatives , modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system that supports a document-centered discussion among heterogeneous display devices comprising:
an invitation storage memory that stores invitation information regarding invitations to discuss a document;
a view storage memory that stores view information for each active discussion;
a controller that controls the invitation storage memory and the view storage memory to specify invitation information for at least one user specifying view information for an accepted invitation stored in the view storage memory.

2. The system of claim 1, further comprising a user contact storage memory that stores user contact information, and wherein the invitation information stored in the invitation storage memory for at least one invitation includes information from the user contact storage memory.

3. The system of claim 2, wherein each user contact entry of the user contact storage memory includes at least one of a user identifier and a device identifier.

4. A method for supporting document-centered discussion among heterogeneous display devices, comprising:
entering invitation information to a discussion into an invitation store;
identifying invitees to the discussion based on the invitation information in the invitation store;
determining invitation acceptance and for accepted invitation, entering invitee specific information and invitation information into a view store;
updating invitee view information based on in the current focus of attention;
viewing information for the invitee based on context information of the inviter.

5. The method of claim 4, further comprising displaying the document based on stored user information.

6. The of claim 5, further comprising displaying the document using at least one of a device type, a device identifier and a display capability from a user contact information store.

7. A method for transferring user discussion messages comprising the steps of:
receiving a message;
determining if a message is a discussion message;
entering the discussion message into a communication queue;
if messages are to be removed from the queue, removing discussion messages from the queue first and removing non-discussion messages after all discussion messages have been removed.

8. The method of claim 7, where the discussion message is at least one of a view information update message, an invitation message and an invitation update message
